(19) United States
(12) Patent Application Publication
(10) Pub. No.: US 2017/0001794 A1
(43) Pub. Date: Jan. 5, 2017

(54) Process of Preparing Ground Coffee Ingredient and Capsule Containing Such Ingredient

(71) Applicant: NESTEC S.A., Vevey (CH)

(72) Inventors: Patricia Ann Mathias, Lithia, FL (US); Abdenour DJAMER, Lausanne (CH); Olivier VILLAIN, Noville (CH); Christian GUENAT, L'Auberson (CH); Céline SARRAZIN-HORISBERGER, Suchy (CH); Frédéric MESTDAGH, Epalinges (CH); Paul EICHLER, Republic of Singapore (SG); Ulrich KESSLER, Savigny (CH); Etienne CLOSSET, Corcelles-Cormondrèche (CH)

(73) Assignee: NESTEC S.A., Vevey (CH)

(21) Appl. No.: 15/109,947

(22) PCT Filed: Dec. 19, 2014
(86) PCT No.: PCT/EP2014/078711

§ 371 Date: Jul. 6, 2016

(30) Foreign Application Priority Data
Jan. 8, 2014 (EP) 14150446.4

(51) Int. Cl. B65D 85/804; A23F 5/04; B65D 81/20; A23F 5/08

(52) U.S. Cl. CPC B65D 85/8043; A23F 5/08; A23F 5/04; B65D 81/2015

(57) ABSTRACT

A process of preparing a capsule comprising a ground coffee ingredient, the process comprising the steps of:

(a) cooling a coffee ingredient to a temperature of −50° C. to 10° C.;
(b) grinding the coffee ingredient, optionally wherein the coffee ingredient is cooled during grinding;
(c) filling the coffee ingredient into a first capsule element, optionally wherein the coffee ingredient is cooled during filling;
(d) hermetically sealing the first capsule element with a second capsule element, optionally wherein the coffee ingredient is cooled during sealing.

### CROSS REFERENCE TO RELATED APPLICATIONS/INCORPORATION BY REFERENCE STATEMENT

This application is a US national stage application filed under 35 USC §371 of International Application No. PCT/EP2014/078711, filed Dec. 19, 2014; which claims priority to Application No. EP 14150446.4, filed Jan. 8, 2014. The entire contents of the above-referenced application are hereby expressly incorporated herein by reference.

### BACKGROUND

The presently disclosed and/or claimed inventive concept(s) generally relates to processes for the preparation of coffee ingredients and to capsules comprising these coffee ingredients. Capsule elements and capsules are also provided.

During the processing and storage of coffee ingredients a partial loss of volatile substances (VSs), such as volatile organic compounds (VOCs), occurs. A reduction in the content of VSs is undesirable, since it results in a reduced quality of the obtained product. The reduction of VSs has been partially attributed to the influence of heat in the processing of the coffee ingredients.

For example, coffee is typically processed by first roasting the coffee beans. The roasted coffee then is allowed to rest so as to slowly cool down, and afterwards is subjected to grinding. The roasting process is what produces the characteristic flavor of coffee by causing the green coffee beans to expand and to change in color, aroma and density. The oils and aromatic volatiles contained and/or developed during roasting confer the aroma and flavor of the coffee beverage produced therefrom, but are also prone to degradation when exposed to the oxygen in the surrounding air. The roasting process also causes the production of gases within the coffee beans, primarily carbon dioxide and carbon monoxide. These gases are slowly evolved by the coffee subsequent to roasting. Grinding the roasted coffee beans will accelerate this process.

A significant loss of VSs can occur during the further processing steps and in particular during grinding.

Therefore, it has been suggested to keep the coffee cool during further processing steps. Likewise, it has been suggested to store the obtained product in the cold.

However, despite these efforts, loss of VSs occurs, resulting in a reduced aroma of the obtained product and often also in further deterioration during storage.

US20120171333 relates to an extended shelf-life package comprising coffee and either an oxygen scavenger or a carbon dioxide scavenger; the container being substantially impervious to oxygen or carbon dioxide. However, coffee aroma and flavour are necessarily also absorbed together with oxygen or carbon gas by the scavenger, thereby diminishing the content of aroma and flavour contained in the coffee powder and in the head space of the container. Therefore, the absorbed coffee aroma and flavour are so no longer available in the coffee extract prepared from the container or as gas to promote coffee odour in the surroundings when the container is opened.

EP0534051A1 relates to a method of manufacturing roasted coffee beans comprising the steps of: a) roasting a desired quantity of coffee beans; and b) rapidly cooling the desired quantity of roasted beans to a temperature of at least −17° C. within 3.5 minutes immediately after roasting.

Japan Published Unexamined Patent Application No. S52-117471 discloses pulverizing roasted beans after freezing the beans to a range of from −79 to −196° C.

Japan Published Examined Patent Application No. S60-25100 (Japan Published Unexamined Patent Application No. S57-208947) discloses, in an ordinary method, freezing and pulverizing roasted beans impregnated with polyatomic alcohol.

Japan Published Examined Patent Application No. S61-32944 (Japan Published Unexamined Patent Application No. S55-26887) discloses freezing beans with liquid nitrogen and pulverizing them to 45 microns or less. All three methods include the steps of pulverizing roasted beans into particles with a diameter of the order of tens of microns and adding the obtained particles to instant coffee obtained in ordinary manufacturing methods.

It is therefore desirable to provide improved processes for the preparation of coffee ingredients, in particular of ground coffee, which allow the reduction of the loss of VSs from the ingredient. It is also desirable to provide improved means for use in relation with these processes and for improved processed ingredients.

### BRIEF DESCRIPTION OF THE DRAWINGS

FIG. 1 shows a non-limiting block diagram depicting essential and optional steps of a process according to the presently disclosed and/or claimed inventive concept(s).

FIG. 2 shows a non-limiting block diagram depicting essential and optional steps of a process according to the presently disclosed and/or claimed inventive concept(s).

FIG. 3 shows non-limiting schematic drawings of a capsule according to the presently disclosed and/or claimed inventive concept(s).

FIGS. 4 to 6 show results of determining sensory profiles of capsules.

FIGS. 7 to 8 show results of experiments analyzing the impact of the capsule rim angle.

### DETAILED DESCRIPTION

The presently disclosed and/or claimed inventive concept(s) is defined according to independent claim 1. The dependent claims further define the presently disclosed and/or claimed inventive concept(s).

In particular, the presently disclosed and/or claimed inventive concept(s) provides a process of preparing a capsule comprising a ground coffee ingredient, the process comprising the steps of: (a) cooling a coffee ingredient, in particular coffee beans, to a temperature of −50° C. to 10° C.; (b) grinding the coffee ingredient, in particular coffee beans, optionally wherein the coffee ingredient is cooled during grinding; (c) filling the ground coffee ingredient into a first capsule element, optionally wherein the coffee ingredient is cooled during filling; and (d) hermetically sealing the first capsule element with a second capsule element, optionally wherein the coffee ingredient is cooled during sealing. The process can comprise the preliminary step of: (a)′ roasting the coffee ingredient, in particular, coffee beans. Step (a)′ can be performed prior to step (a).

The process can comprise the step of: (a)″ tempering the coffee ingredient, in particular, the roasted coffee beans. Step (a)″ can be performed prior to step (a). Step (a)″ can be performed after step (a)′ and prior to step (a).

The process can comprise the step of: (c)′ compressing the coffee ingredient, optionally wherein the coffee ingredient is cooled during compressing. Step (c)′ can be performed after step (b) and prior to step (c).

The process can comprise the step of: (c)″ degasification of the coffee ingredient, optionally wherein the coffee ingredient is cooled during degasification. Step (c)″ can be performed after step (b) and prior to step (c). Step (c)″ can be performed after step (c)′ and prior to step (c). In certain non-limiting embodiments, degasification is kept short to enable a partial loss of the gas contained in the coffee ingredient.

Degasification in step (c)″ can be performed for 120 min or less, for 60 min or less, for 35 min or less, for 25 min or less, for 20 min or less, for 15 min or less, for 10 min or less, or for 5 min or less.

According to some embodiments, the process does not comprise a degasification step (c)″, or does not comprise any degasification step.

In step (a), the coffee ingredient can be cooled to a temperature of −50° C. to 5° C., −45° C. to 5° C., −40° C. to 0° C., −35° C. to −5° C., −30° C. to −10° C., −25° C. to −15° C., or −20° C.

The coffee ingredient can be maintained at a temperature of −50° C. to 10° C. in step (b). The coffee ingredient can be maintained at a temperature of −50° C. to 10° C. in step (c). The coffee ingredient can be maintained at a temperature of −50° C. to 10° C. in step (c)′. The coffee ingredient can be maintained at a temperature of −50° C. to 10° C. in step (c)″. The coffee ingredient can be maintained at a temperature of −50° C. to 10° C. in step (d).

The coffee ingredient can be maintained at a temperature of about −50° C. to about 10° C. in step (b) and/or in step (c) and/or in step (c)′ and/or in step (c)″ and/or in step (d). The coffee ingredient can be maintained at a temperature of −45° C. to 5° C., −40° C. to 0° C., −35° C. to −5° C., −30° C. to −10° C., −25° C. to −15° C., or −20° C. in one or more, and in certain non-limiting embodiments all, of these steps. The temperature can be selected independently for each step.

The first capsule element can comprise a rim for sealing engagement with the second capsule element, at least one sidewall, and a bottom wall, wherein the at least one side wall and the bottom wall define an interior chamber having an opening, the opening spanning a plane, wherein further the rim extends outwards from the sidewall and surrounds the opening, the rim being bent into the direction of the bottom wall, the rim and the plane of the opening forming an angle of at least 10, such as (but not limited to) at least 12°. The angle can be 10° to 31°, such as 12° to 28°, 12° to 26°, 14° to 24°, 16° to 22°, or 18° to 20°. The angle can be 10°, 11°, 12°, 13°, 14°, 15°, 16°, 17°, 18°, 19°, 20°, 21°, 22°, 23°, 24°, 25°, 26°, 27°, 28°, 29°, or 30°. In certain non-limiting embodiments, the angle is 12° to 28°, such as 16° to 28°, or 18° to 26°. Even more particular (but non-limiting) are angles of 20° to 28°, such as 22° to 26°, or 24°.

As will be explained later on, the angle provides a higher resistance of the second element sealed onto the first element to delamination and/or breakage and so allows the gas to emanate in the sealed capsule and generate a positive pressure without risk of damage of the capsule.

A vacuum or a reduced pressure can be applied to the first capsule element after filling the ground coffee ingredient into the first capsule element and before the first capsule element is hermetically sealed with the second capsule element.

The reduced pressure applied to the first capsule element can be 100 mbar to 800 mbar under atmospheric pressure.

The first capsule element can be a capsule body. The first capsule element can be rotationally symmetric. The first capsule element can be of essentially frusto-conical shape or of frusto-conical shape.

The second capsule element can be a membrane. The membrane can have a thickness of about 30 μm to about 40 μm. The membrane can be impermeable for CO₂. In certain non-limiting embodiments, the membrane is gas-tight.

In certain particular, non-limiting embodiments, the coffee ingredient is roasted coffee.

The presently disclosed and/or claimed inventive concept(s) also provides a capsule obtainable by the process according to the presently disclosed and/or claimed inventive concept(s).

The presently disclosed and/or claimed inventive concept(s) further provides a capsule element for a capsule comprising a ground coffee ingredient, wherein the capsule element comprises a rim for sealing engagement with a second capsule element, at least one sidewall, and a bottom wall, wherein the at least one side wall and the bottom wall define an interior chamber having a opening, the opening spanning a plane, wherein further the rim extends outwards from the sidewall and surrounds the opening, the rim being bent into the direction of the bottom wall, the rim and the plane of the opening forming an angle of at least 10°, such as (but not limited to) at least 12°.

The angle can be 10° to 31°, such as 10° to 28°, such as 12° to 26°, 14° to 24°, 16° to 22°, or 18° to 20°.

The sidewall can have an upper and a lower end, the upper end defining a circle having a first diameter, the lower end defining a circle having a second diameter, wherein the opening is located at upper end, optionally wherein the second diameter is smaller than the first diameter. The bottom wall can be located at the lower end. The bottom wall can be located opposite the opening.

The first capsule element can be a capsule body. The first capsule element can be rotationally symmetric. The first capsule element can be of essentially frusto-conical shape or of frusto-conical shape.

Also, the presently disclosed and/or claimed inventive concept(s) provides for a capsule comprising as a first capsule element a capsule element as described above, the capsule further comprising a second capsule element for sealing connection with the rim of the first capsule element.

The second capsule element can be in sealing connection with the rim.

The second capsule element can be a membrane. The membrane can have a thickness of 30 μm to 40 μm. The membrane can be impermeable for carbon gas (CO2, CO) and aroma volatiles. In certain non-limiting embodiments, the membrane is gas-tight.

The capsule can comprise a coffee ingredient, such as (but not limited to) roast and ground coffee.

The presently disclosed and/or claimed inventive concept(s) and its advantages are now described in more detail. It is understood that the examples and drawings provided herein serve to illustrate aspects of the presently disclosed and/or claimed inventive concept(s), however are not to be construed as limiting to the scope of the presently disclosed and/or claimed inventive concept(s). Likewise, headlines used in this section are provided for the convenience of the reader, however are not to be construed as limiting.

Processes According to the Presently Disclosed and/or Claimed Inventive Concept(s)

The presently disclosed and/or claimed inventive concept(s) proposes to improve the aromatic features of the coffee in the capsule so that a higher in-cup and/or above-cup aroma intensity of the coffee extract can obtained. Accordingly, the presently disclosed and/or claimed inventive concept(s) proposes to reduce the loss of aroma volatiles during the processing of coffee ingredients, such as coffee, by cooling the coffee ingredient, and, in certain non-limiting embodiments, by ensuring the maintenance of a cold environment during further processing steps such as grinding, optional compacting and optional (reduced) degasification, and eventually filling and capsule sealing such as (but not limited to) under vacuum.

The processes according to the presently disclosed and/or claimed inventive concept(s) allow to reduce the loss of VSs, such as VOCs, and also allow to reduce oxidation processes occurring during processing and subsequent storage of the processed coffee ingredient. This is reflected in an improved aroma of the obtained product.

The present inventors have found that surprisingly, loss of VSs, such as VOCs, in the processing of coffee ingredients (in particular of coffee), can be significantly reduced when at least a part of the processing is performed under cold conditions, applying the specific process parameters described herein.

Accordingly, the aroma quality of coffee was found to be significantly increased when processed according to a process of the presently disclosed and/or claimed inventive concept(s), especially when the aroma above the cup and in the cup was compared to products of the prior art.

Moreover, the quality of the obtained ground coffee product was found to be considerably improved when the product was filled after reduced degasification into a dedicated capsule and the capsule subsequently was hermetically sealed.

Accordingly, in one aspect the presently disclosed and/or claimed inventive concept(s) provides a process of preparing a capsule comprising a ground coffee ingredient.

The coffee ingredient filled in the capsule can be any coffee ingredient that can be provided in roast and ground form. However, it is most for the disclosure of the presently disclosed and/or claimed inventive concept(s) throughout that the coffee ingredient is coffee in any suitable form, such as in the form of coffee beans, for example roasted coffee beans.

Thus, the coffee ingredient subjected to the process of the presently disclosed and/or claimed inventive concept(s) can be coffee, for example coffee beans, which may be roasted coffee beans.

The capsule can be any capsule suitable for filling with coffee ingredients, in particular ground coffee ingredients. Typically, the capsule comprises a first capsule element and a second capsule element. In certain non-limiting embodiments, the capsule is sealable, such as (but not limited to) hermetically sealable. According to a particular non-limiting embodiment, the capsule is sealable, or is hermetically sealable, by sealing engagement of the first and second capsule elements. The first and second capsule elements can be the same, or can be different from each other. It is also desired in certain non-limiting embodiments that the capsule material or materials exhibit very low gas permeability, or no gas permeability at all. In certain particular, non-limiting embodiments, the capsule is substantially gas tight, or is gas tight, once sealed or hermetically sealed. Also, it is very desirable that the capsule is adapted to withstand comparably high internal pressure, such as an internal pressure of 300 mbar to 500 mbar, 325 mbar to 475 mbar, 350 mbar to 450 mbar, 375 mbar to 425 mbar or 400 mbar. Especially, the pressure is due to the degasification of the coffee ingredient after sealing of the capsule. Also, it is desired in certain non-limiting embodiments that the capsule is adapted for insertion into a beverage production device. In certain non-limiting embodiments, the capsule is adapted to withstand an internal pressure of at least 350 mbar, at least 400 mbar, or at least 450 mbar, such as 400 mbar to 500 mbar, such as (but not limited to) 450 mbar to 500 mbar. A capsule may be adapted to withstand internal pressure if it remains intact, e.g. hermetically sealed, at said pressure.

The capsule can comprise or can be made of any suitable material such as, but not limited to, aluminium or a polymer composition or a combination thereof. The polymer composition can be polypropylene or polyethylene. Aluminium is a desired (but non-limiting) material.

Further desirable features and properties of the capsule elements and capsules will be described below.

In step (a) of the process, a coffee ingredient, in the form of roasted whole coffee beans, is cooled to a temperature of −50° C. to 10° C.

The coffee ingredient can be cooled to a temperature of −45° C. to 5° C., −40° C. to 0° C., −35° C. to −5° C., −30° C. to −10° C., −25° C. to −15° C., or −20° C. In certain non-limiting embodiments, the coffee ingredient is cooled to a temperature of −30° C. to −10° C., such as (but not limited to) a temperature of −25° C. to −15° C., or −20° C.

Cooling step (a) can be performed so that the coffee ingredient is cooled to the desired temperature comparably fast, for example within 30 min or less, within 20 min or less, within 10 min or less, or within 5 min or less, from the onset of cooling.

If the cooling step (a) is preceded by a roasting and/or tempering step, it is desired in certain non-limiting embodiments that the cooling step is carried out quickly (for example, within 60 min or less, within 40 min or less, within 20 min or less, within 10 min or less, or within 5 min or less) after the end of the roasting step or tempering step.

However if desired, the coffee ingredient can be stored for a certain amount of time after cooling down and prior to grinding step (b). The storing can be at a temperature of −50° C. to 10° C., for example at −45° C. to 5° C., −40° C. to 0° C., −35° C. to −5° C., −30° C. to −10° C., such as (but not limited to) at −25° C. to −15° C., or −20° C. Storage at temperatures of −5° C. to 10° C., such as −3° C. to 8° C., 2° C. to 7° C., or 5° C. is likewise contemplated. The coffee ingredient can for example be stored for at least about one hour, at least about two hours, at least about five hours or from about one hour to about 24 hours. After the cooling step, for example due to operational constraints in case of line stoppage, the cold beans may be kept stored before grinding between 0 minutes (=no line stoppage) up to 5 min, up to 30 min, up to 1 hour depending the unplanned time stoppage. So that when the line restart after stoppage, the cold beans are fed into the grinder at the right temperature.

In the alternative, the grinding step (b) can be performed after cooling step (a) without storing the coffee ingredient after cooling step (a).

In grinding step (b) of the process, which is typically carried out after cooling step (a), the coffee ingredient is ground.

Grinding typically is accompanied by the development of heat (typically due to the mechanical forces generated by the mill and coffee). Thus, in certain non-limiting embodiments), the coffee ingredient is cooled during grinding. The coffee ingredient can be cooled to or maintained at a temperature of −50° C. to 10° C., −45° C. to 5° C., −40° C. to 0° C., −35° C. to −5° C., −30° C. to −10° C., −25° C. to −15° C., or −20° C. Particular (but non-limiting) are temperatures of −5° C. to 10° C., such as −3° C. to 8° C., 2° C. to 7° C., such as (but not limited to) 5° C. A temperature of −25° C. to −15° C., or −20° C. is likewise desired in certain non-limiting embodiments.

Filling step (c) of the process is typically performed after grinding step (b). In this step, the coffee ingredient is filled into a first capsule element. Again, it is desired in certain non-limiting embodiments that the coffee ingredient is cooled during this step, to avoid loss of VSs. Accordingly, the coffee ingredient can be cooled to or maintained at a temperature of −50° C. to 10° C., −45° C. to 5° C., −40° C. to 0° C., −35° C. to −5° C., −30° C. to −10° C., −25° C. to −15° C., or −20° C. in step (c). In certain non-limiting embodiments, desired temperatures are of −5° C. to 10° C., such as −3° C. to 8° C., or 2° C. to 7° C., such as (but not limited to) 5° C. A temperature of −25° C. to −15° C., or −20° C. is likewise desired in certain non-limiting embodiments.

In a further step, step (d), the first capsule element is hermetically sealed with a second capsule element. As a result, the first and second capsule elements are connected with one another and may form a completely closed capsule. The connection formed by hermetically sealing may be complete and substantially air tight, or air tight. In certain particular, non-limiting embodiments, the connection is gas tight. The hermetically sealing may comprise welding and/or crimping. Furthermore, no gas scavenger is filled or inserted into the first capsule element before sealing by the second element.

Again, it is desired in certain non-limiting embodiments that the coffee ingredient is cooled during this step. Thus, the coffee ingredient can be cooled to or maintained at a temperature of −50° C. to 10° C., −45° C. to 5° C., −40° C. to 0° C., −35° C. to −5° C., −30° C. to −10° C., −25° C. to −15° C., or −20° C. in step (d). In certain non-limiting embodiments, desired temperatures are of −5° C. to 10° C., such as −3° C. to 8° C., or 2° C. to 7° C., such as (but not limited to) 5° C. A temperature of −25° C. to −15° C., or −20° C. is likewise desired in certain non-limiting embodiments.

Albeit not required, the process may comprise one or more additional steps.

For example, the process may further comprise step (a)′, in which the coffee ingredient is roasted. The conditions applied during roasting are not particularly limited and may be as known in the art. If the process encompasses roasting step (a)′, step (a)′ is performed prior to step (a).

In other words, according to some embodiments, step (a) may not be the initial step of the process according to the presently disclosed and/or claimed inventive concept(s).

In the alternative or in addition, the process may further comprise step (a)″, in which tempering of the coffee ingredient is performed. Tempering aims at homogenising the water content of the coffee ingredient. It can be performed by storing the coffee ingredient for a given amount of time (such as of 60 to 80 minutes) generally under ambient temperature and under modified atmosphere (e.g. saturated with nitrogen gas).

If the process comprises tempering step (a)″, said step is performed prior to step (a). In embodiments where the process encompasses both, step (a)′ and step (a)″, step (a)″ can be performed after step (a)′ and prior to step (a).

In the alternative or in addition, the process may further comprise step (c)′, wherein the coffee ingredient is compressed or normalized. Generally, the coffee ingredient is beaten or mixed/homogenised to obtain the right density (e.g., 420 g/L for 5.5 g of coffee ingredient) and then the capsule is filled in with the right weight of coffee ingredient.

Again, it is desirable that the coffee ingredient is cooled during this step. Accordingly, the coffee ingredient can be cooled to or maintained at a temperature of −50° C. to 10° C., −45° C. to 5° C., −40° C. to 0° C., −35° C. to −5° C., −30° C. to −10° C., −25° C. to −15° C., or −20° C. in step (c)′. In certain non-limiting embodiments, desired temperatures are of −5° C. to 10° C., such as −3° C. to 8° C., or 2° C. to 7° C., such as (but not limited to) 5° C. A temperature of −25° C. to −15° C., or −20° C. is likewise desired in certain non-limiting embodiments.

Typically, step (c)′ is performed after step (b) and prior to step (c).

Certain coffee ingredients, such as for example coffee, are typically processed by methods that encompass a degasification step, in particular after the coffee ingredient has been ground. Due to the enlarged ingredient surface formed as a result of grinding, degasification is typically allowed for after grinding. During degasification, the emission of carbon gas (CO₂ and CO) developing due to the roasting process from ground coffee ingredient is allowed for.

Accordingly, in the alternative or in addition, the process according to the presently disclosed and/or claimed inventive concept(s) may further comprise step (c)″, degasification of the coffee ingredient. Step (c)″ can be performed after step (b) and prior to step (c), or after step (c)′ and prior to step (c).

It should be noted that according to typical methods of the prior art, the degasification step is performed at ambient temperature and requires considerable amounts of time, and may take up to 72 hours or even longer. However, the prior art has paid little attention to the significance of this step in relation with oxidation processes and loss of VSs from the coffee product.

The present inventors found the quality of the obtained coffee product to be even further improved when the time between the end of the grinding step and the hermetically sealing of the capsule was reduced. Accordingly, in a particular (but non-limiting) embodiment of the process according to the presently disclosed and/or claimed inventive concept(s), the time between the end of the grinding step and the hermetically sealing of the capsule is reduced, e.g. is reduced to less than 180 min, less than 150 min, less than 120 min, less than 90 min, less than 60 min, less than 45 min, less than 30 min or even less than 20 min.

In particular, the present inventors have also found that a reduction in the duration of the degasification step (c)″ advantageously reflects on the quality of the obtained product, since oxidization processes and loss of VSs, such as VOCs, is reduced. Without wishing to be bound by theory, the inventors have found that the carbon gas (CO₂, CO) emitted from the coffee ingredient during the degasification step comprises large amounts of VSs. The reduction of the processing times from the end of the grinding step to the hermetically sealing of the capsule was found to significantly decrease the loss of VSs due to emission of carbon gas. A reduction in the duration of the degasification step itself has been found particular useful, especially when combined with maintaining the coffee product at comparably cool temperatures during the degasification step.

Accordingly, it is desired in certain non-limiting embodiments that the degasification step (c)″, if present, is performed for 40 min or less, for 35 min or less, for 30 min or less, for 25 min or less, for 20 min or less, for 15 min or less, for 10 min or less, or for 5 min or less. In certain particular, non-limiting embodiments, the duration of step (c)″ is 35 min to 5 min, such as (but not limited to) 20 min to 10 min.

Likewise, it has been found that cooling the coffee ingredient during degasification further helps to retain VSs and to reduce oxidation processes. Accordingly, it is desired in certain non-limiting embodiments that the coffee ingredient in step (c)″ is cooled. In certain particular, non-limiting embodiments, the coffee ingredient is cooled to or maintained at a temperature of −50° C. to 10° C., −45° C. to 5° C., −40° C. to 0° C., −35° C. to −5° C., −30° C. to −10° C., −25° C. to −15° C., or −20° C. in step (c)″. In certain non-limiting embodiments, desired temperatures are of −5° C. to 10° C., such as −3° C. to 8° C., or 2° C. to 7° C., such as (but not limited to) 5° C. A temperature of −25° C. to −15° C., or −20° C. is likewise desired in certain non-limiting embodiments.

Reduction in duration of step (c)″ and cooling, as detailed above, can advantageously be applied in combination.

As already indicated above, the coffee ingredient can be cooled in one or more steps of the process according to the presently disclosed and/or claimed inventive concept(s). Also, the coffee ingredient can be maintained at a certain temperature in one or more steps of the process according to the presently disclosed and/or claimed inventive concept(s). While apart from cooling step (a), cooling is not required, it is nevertheless desired in certain non-limiting embodiments that the coffee ingredient is cooled in at least one of steps (b), (c), (d), and —insofar as present—(c)′ and (c)″. In certain particular, non-limiting embodiments, the coffee ingredient is cooled in all of these steps. In certain particular, non-limiting embodiments, the coffee ingredient is maintained at a temperature of about −50° C. to about 10° C. in at least one of steps (b), (c), (d), and—insofar as present—(c)′ and (c)″. In certain particular, non-limiting embodiments, the coffee ingredient is maintained at a temperature of about −50° C. to about 10° C. in all of these steps. The temperature may be chosen independently for each step.

Means for cooling and/or maintaining a coffee ingredient at a desired temperature that can be applied in the process according to the presently disclosed and/or claimed inventive concept(s) are readily available to the skilled person. For example, and without limitation, cooling and/or maintaining of the coffee ingredient at the desired temperature can be achieved by cold inert substances, such as liquid nitrogen or solid carbon dioxide. These substances can be brought in direct contact with the coffee ingredient, or can be provided in a closed system that is in contact with or in proximity to the coffee ingredient. A fan or similar equipment can be used to remove evaporating gas, such as evaporating liquid nitrogen, from the coffee ingredient or the system if desired.

In the alternative or in addition, freezing devices can be used, such as blast freezers, spiral freezers or tunnel freezers. Likewise, cooling units such as water cooling units can be used. Also, cooling can be achieved by circulation of a cold fluid inside double jacketed equipment. A cooling fluid can be circulated in the water circuit of the grinder, the normalizer used for compacting and/or the degasing unit.

While cold temperatures during the degasification step and reduction of the degasification time were found to work well, best effects where obtained when the degasification step was omitted entirely from the process according to the presently disclosed and/or claimed inventive concept(s). Thus, according to one aspect, the present process does not comprise a long degasification step (c)″, or does not comprise any degasification step (i.e. neither comprises a step (c)″ as detailed above nor any other dedicated degasification step).

Besides advantages relating to the quality of the obtained product, reduced processing times improve the efficacy of the entire process. Thus, reduced processing times, in particular reducing the duration of the degasification step or omitting said step entirely, offer clear advantages, especially when combined with maintaining the coffee product at comparably cool temperatures during some or all steps of the process.

Yet, emission of carbon gas from the coffee ingredient during filling, sealing and even thereafter, is a further effect of the reduced processing times that is particularly pronounced if the time allowed for the degasification step is reduced, degasification is carried out while maintaining the product at cold temperatures, or the process does not comprise any degasification step at all.

On the one hand, the emitted gas advantageously helps to further reduce oxidation processes that may occur in the coffee ingredient, because the contact of the oxygen comprised in the surrounding atmosphere with the coffee ingredient is minimized and the emitted gas builds a less oxidizing atmosphere in the sealed capsule. This may abolish the need for inert gas to create a non-oxidizing atmosphere during processing steps and also within the capsule. Yet, inert gas, such as nitrogen, can nevertheless be used if desired.

On the other hand however, the emission of gas in the sealed capsule may result in an elevated pressure within the capsule, especially if the capsule is hermetically sealed. However, hermetically sealing of the capsule is highly desirable to avoid the eventual loss of VSs along with CO₂ escaping from the capsule, to avoid the exposure to oxygen entering the capsule and for general hygiene considerations.

The elevated pressure occurring is especially problematic in capsules adapted for insertion into and/or use with a beverage production device. Many of these devices rely on the interaction of a coffee ingredient provided in a capsule with a liquid, such as hot water, that enters the capsule under pressure, for example through a slit or the like in the capsule created in the beverage production device. To retrieve the liquid from the capsule, the capsule is typically adapted to allow for the opening of the capsule upon injection of a pressurized liquid during machine extraction, e.g. by tearing or disruption of a capsule element, such as a membrane.

Generally, since the capsule comprises a capsule element, such as a membrane, intended to be torn under liquid pressure in the machine during extraction, the capsule element can burst and break or delaminate if a too high pressure of gas is created in the capsule during storage. This can be the case if a coffee ingredient, such as coffee is not or not sufficiently degased before the filling and sealing steps and therefore coffee produces gas in the sealed capsule.

The possibilities of making such a capsule more pressure resistant by simply providing a thicker and/or stronger material are limited, because otherwise, the capsule would no longer open readily upon injection of a pressurized liquid.

Thus, according to one aspect, the presently disclosed and/or claimed inventive concept(s) provides for the use of a first and second capsule element in the process according to the presently disclosed and/or claimed inventive concept(s), wherein the first capsule element comprises a rim for sealing engagement with the second capsule element, and further comprises at least one sidewall, and a bottom wall. The first capsule element can for example comprise one, at least two, at least three, at least four, at least five, or at least ten sidewalls. It may be desired in certain non-limiting embodiments that the first capsule element comprises one sidewall such as a frusto-conical sidewall.

The at least one side wall and the bottom wall define an interior chamber having an opening. The opening spans a plane. In certain non-limiting embodiments, the rim of the first capsule element extends outwards from the sidewall and surrounds the opening. In certain particular, non-limiting embodiments, the rim is bent into the direction of the bottom wall, the rim and the plane forming an angle of at least 10°, such as (but not limited to) at least 12°. The angle formed may be 10° to 31°, 10° to 28°, 12° to 26°, 14° to 24°, 16° to 22°, or 18° to 20°. The angle can be 10°, 11°, 12°, 13°, 14°, 15°, 16°, 17°, 18°, 19°, 20°, 21°, 22°, 23°, 24°, 25°, 26°, 27°, 28°, 29°, or 30°. In certain non-limiting embodiments, the angle is 12° to 28°, such as 16° to 28°, or 18° to 26°. Other particular non-limiting embodiments are angles of 20° to 28°, such as 22° to 26°, or 24°.

The rim can be pre-bent, and thus present before a sealing engagement between the first capsule element and a further capsule element occurs.

The rim of the first capsule element can comprise a flat annular part. The rim of the first capsule element may be a flange-like rim. The rim of the first capsule element may be a flange-like rim comprising a flat annular part.

The angle can be determined prior to the sealing connection of the first capsule element with the second capsule element, for example on the first capsule element taken in isolation, in particular if the rim is a pre-bent rim.

Without wishing to be bound by theory, the present inventors have found that surprisingly, the angle between the rim and the plane of the opening attributes increased pressure resistance to the hermetically sealed capsule obtained by sealing the first and second capsule elements in step (d) of the process according to the presently disclosed and/or claimed inventive concept(s).

The first capsule element may be a capsule body.

According to a particular (but non-limiting) embodiment, the first capsule element is rotationally symmetric and/or is of essentially frusto-conical shape, or frusto-conical shape.

In certain non-limiting embodiments, the second capsule element is a membrane.

The membrane can have a thickness about 30 μm to about 40 μm. In certain non-limiting embodiments, the membrane is impermeable for air (CO₂, CO, O2, N2, . . . ) and coffee aroma volatiles, i.e., gas-tight. The membrane can comprise or consist of any suitable material, such as aluminium or a multi-layer comprising the following layers (from exterior to interior): PET/Colour layer/Adhesive/Aluminium/Adhesive/OPP.

Capsule elements and capsules useful in the process according to the presently disclosed and/or claimed inventive concept(s) will be described in even further detail below.

According to a further aspect, a vacuum or a reduced pressure can be applied to the first capsule element. Thus, a partial vacuum or reduced pressure can be created within the capsule by providing a negative pressure before fully sealing the capsule. This way, the coffee ingredient, such as coffee, in the capsule is given the capacity to release carbon gas while maintaining the pressure inside the capsule sufficiently low.

A vacuum or a reduced pressure can be applied to the first capsule element or capsule after filling the ground coffee ingredient into the first capsule element and before the first capsule element is entirely hermetically sealed with the second capsule element. The reduced pressure applied to the first capsule element can be 100 mbar to 800 mbar under atmospheric pressure, such as 200 mbar to 700 mbar, 300 mbar to 600 mbar, or 400 mbar to 500 mbar under atmospheric pressure. It is desired in certain non-limiting embodiments that the reduced pressure applied is 600 mbar to 800 mbar, such as 650 mbar to 750 mbar, or 700 mbar to 770 mbar under atmospheric pressure. In normal conditions, the atmospheric pressure can be generally 1013.25 mbar (+/−100).

The reduced pressure can be applied prior to step (d) and/or during sealing step (d). The vacuum or reduced pressure can be applied after filling step (c) and prior to sealing step (d). The vacuum or reduced pressure can be applied after filling step (c) and during sealing step (d). The vacuum or reduced pressure may be applied at some point during step (d), before the hermetically sealing is fully completed.

During application of the vacuum or reduced pressure, the coffee ingredient can be cooled, and/or can be maintained at a certain temperature, as desired. For example, the coffee ingredient can be cooled to or maintained at a temperature of −50° C. to 10° C., −45° C. to 5° C., −40° C. to 0° C., −35° C. to −5° C., −30° C. to −10° C., such as (but not limited to) −25° C. to −15° C., or −20° C. Temperatures of −5° C. to 10° C., such as −3° C. to 8° C., 2° C. to 7° C., or 5° C. are also desired in certain non-limiting embodiments.

Exemplary (but non-limiting) means for applying a vacuum or a reduced pressure that can be used for applying a vacuum or a reduced pressure to a capsule element or capsule are described in co-pending patent application PCT/EP13/063174.

By applying a vacuum or a reduced pressure, the emission of gas in the hermetically sealed capsule can be partially or entirely compensated for. In other words, the increase of pressure in the capsule due to the emanation of carbon gas from the coffee ingredient can be substantially equal to the reduction of pressure applied before sealing step d).

The skilled person understands that both aspects useful to compensate for the emission of gas in the capsule can be used in combination. Hence, the presently disclosed and/or claimed inventive concept(s) also provides for the application of a vacuum or reduced pressure when a first capsule element comprising a rim for sealing engagement with the second capsule element is used, the capsule element further comprising at least one sidewall, and a bottom wall, the side wall and the bottom wall defining an interior chamber having an opening, the opening spanning a plane, the rim of the first capsule element extending outwards from the sidewall and surrounds the opening, the rim being bent into the direction of the bottom wall, the rim and the plane of the opening forming an angle of at least 10°, such as (but not limited to) of at least 12°.

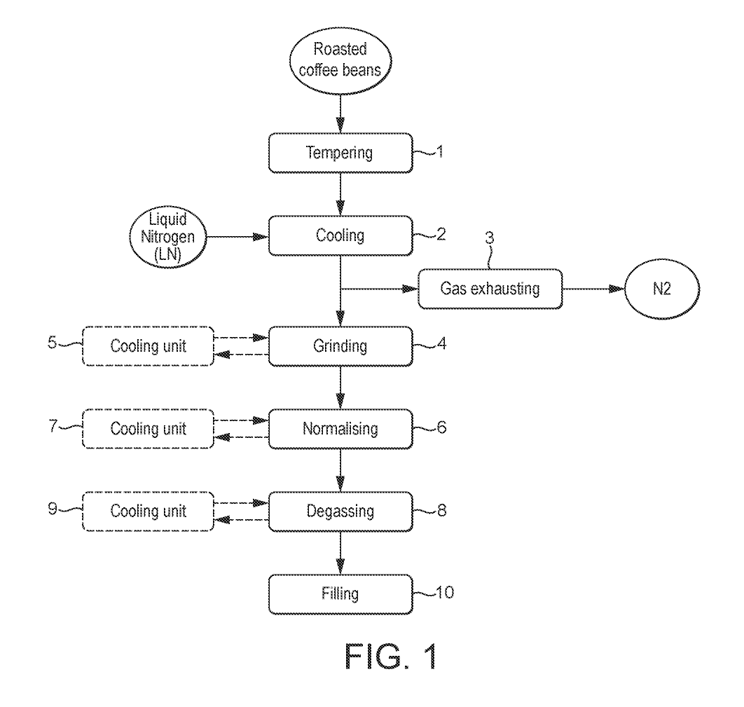

FIG. 1 shows an exemplary, non-limiting example of a process according to the presently disclosed and/or claimed inventive concept(s). According to the exemplary process of FIG. 1, a coffee ingredient that is roasted coffee beans is provided as starting material. The process starts with step 1, tempering of the coffee beans. In a second step 2, the tempered coffee beans are cooled with liquid nitrogen. Optionally, N₂-gas is exhausted 3. This can be done by using a fan or the like. The cooled beans are subsequently subjected to grinding step 4, followed by normalizing or compacting step 6, degassing step 8, and filling step 10. Steps 4, 6, and 8 are carried out while maintaining the coffee ingredient cold. To that end, cooling units 5, 7 and 9 are used for steps 4, 6 and 8, respectively.

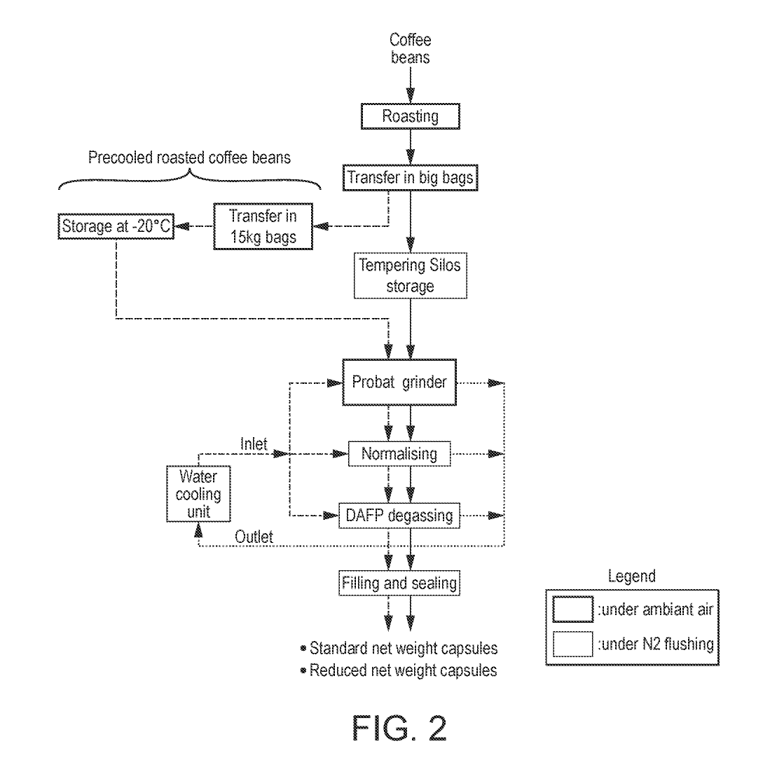

FIG. 2 shows a further exemplary, non-limiting example of a process according to the presently disclosed and/or claimed inventive concept(s). Coffee beans are the coffee ingredient that is used as starting material. The process optionally starts with a roasting step. The roasted beans are transferred for tempering under N₂-flushing, or the beans are cooled to a temperature of −20° C. under ambient air, to provide pre-cooled roasted coffee beans. The pre-cooled coffee beans are then subjected to grinding, followed by a normalizing/compacting step, degasification step, and the steps of filling into capsules and sealing. The grinding step can be performed under ambient air or under cooled conditions such as under N2-flushing, while the normalizing/compacting step, the degasification step, and the steps of filling and sealing are performed under N₂-flushing. A cooling unit provides a cooling fluid such as a mixture of water and glycol for a cooling circuit during grinding, normalizing/compacting, and degasification.

Capsule Elements and Capsules

The presently disclosed and/or claimed inventive concept(s) also provides for a capsule obtainable by a process according to the presently disclosed and/or claimed inventive concept(s). The capsule comprises a ground coffee ingredient, and comprises ground coffee. In certain particular, non-limiting embodiments, the capsule is adapted for insertion into a beverage producing unit. The capsule can be a capsule comprising a membrane as the second capsule element. The capsule can comprise a single serving of the ground coffee ingredient, such as the ground coffee.

A capsule obtainable by a process according to the presently disclosed and/or claimed inventive concept(s) can be distinguished from capsules of the prior art in one or more of the following aspects.

For example, a capsule obtainable by a process according to the presently disclosed and/or claimed inventive concept(s) can comprise a ground coffee ingredient that has a higher content of one or more VSs, such as VOCs, than a capsule comprising a ground coffee ingredient obtainable by a process according to the prior art, when the same coffee ingredient is used as a starting material and the same amount of ground coffee ingredient is comprised within the capsule.

Absolute and/or relative contents in the ground coffee ingredient, such as ground coffee of one or more VSs, such as VOCs, can be higher for a capsule obtainable by a process according to the presently disclosed and/or claimed inventive concept(s). Also, a capsule obtainable by a process according to the presently disclosed and/or claimed inventive concept(s) can comprise more of one or more VSs, such as VOCs, relative to a capsule comprising a ground coffee ingredient obtainable by a process according to the prior art, when the same coffee ingredient is used as a starting material. Non-limiting examples of VSs that can be determined can be selected from the group consisting of thiols, sulfides, Strecker aldehydes, diketones, pyrazines, phenols or a combination thereof.

The aroma in cup of coffee prepared from a capsule obtainable by a process according to the presently disclosed and/or claimed inventive concept(s) was found to be increased by +20% to +30% (compared to the same capsule without the process of the presently disclosed and/or claimed inventive concept(s) as considered as a reference), and the aroma above the cup was found to be increased by +35% to +70% compared to a capsule prepared according to the process of the prior art wherein neither cooling nor reduced or eliminated degasing times were applied.

In the alternative or in addition, a capsule obtainable by a process according to the presently disclosed and/or claimed inventive concept(s) can be characterized by a higher pressure, and/or a higher content or concentration of carbon gas within the capsule than a capsule comprising a ground coffee ingredient obtainable by a process according to the prior art, when the same coffee ingredient is used as a starting material, and the same amount of ground coffee ingredient is comprised within the capsule.

Likewise in the alternative or in addition, a capsule obtainable by a process according to the presently disclosed and/or claimed inventive concept(s) can be distinguished from a capsule of the prior art by the presence of a specific angle between a rim of a first capsule element having an opening and a plane of the opening. In particular, the capsule can be a capsule comprising a first capsule element, the first capsule element comprising a rim for sealing engagement with a second capsule element, at least one sidewall, and a bottom wall, wherein the at least one side wall and the bottom wall define an interior chamber having an opening, the opening spanning a plane, wherein further the rim extends outwards from the sidewall and surrounds the opening, the rim being bent into the direction of the bottom wall, the rim and the plane of the opening forming an angle of at least about 10°, such as (but not limited to) at least 12°.

The presently disclosed and/or claimed inventive concept(s) also provides for a capsule element for a capsule comprising a ground coffee ingredient, wherein the capsule element comprises a rim for sealing engagement with a second capsule element, at least one sidewall, and a bottom wall.

The capsule element can for example comprise one, at least two, at least three, at least four, at least five, or at least ten sidewalls. It is desired in certain non-limiting embodiments that the first capsule element comprises one sidewall, such as (but not limited to) a frusto-conical sidewall.

The at least one side wall and the bottom wall define an interior chamber having an opening. The rim extends outwards from the sidewall and surrounds the opening. The opening spans a plane. In certain non-limiting embodiments, the rim is bent into the direction of the bottom wall. This means that the angle formed by the rim and the sidewall(s) is acute or lower than 90°.

The rim and the plane of the opening form an angle of at least 10°, such as (but not limited to) at least 12°. The angle formed may be 10° to 31°, 10° to 28°, 12° to 26°, 14° to 24°, 16° to 22°, or 18° to 20°. The angle can be 10°, 11°, 12°, 13°, 14°, 15°, 16°, 17°, 18°, 19°, 20°, 21°, 22°, 23°, 24°, 25°, 26°, 27°, 28°, 29°, or 30°. In certain non-limiting embodiments, the angle is 12° to 28°, such as 16° to 28°, or 18° to 26°. Particular non-limiting embodiments are angles of 20° to 28°, such as 22° to 26°, or 24°.

The rim can be pre-bent, and thus be present before a sealing engagement between the capsule element and a further capsule element occurs.

The angle can be determined prior to the sealing connection of the capsule element with the second capsule element, for example on the capsule element taken in isolation, in particular if the rim is a pre-bent rim.

The rim of the capsule element can comprise a flat part, such as (but not limited to) annular. The rim of the capsule element can be a flange-like rim. The rim of the capsule element can be a flange-like rim comprising a flat annular part and a curled flange.

The angle between the rim and the plane of the opening can be determined by the level between two points placed on a flat part of the rim.

The angle between the plane of the opening and the rim can be the angle between the plane of the opening and a straight line passing through two points on the rim, such as (but not limited to) on a flat part of the rim, wherein the two points are points of intersection of a second plane and the rim, the second plane being a plane passing through the centre of the opening and being orthogonal to the plane of the opening.

Capsules comprising a capsule element according to the presently disclosed and/or claimed inventive concept(s) can withstand a higher internal capsule pressure. This is particularly true for embodiments where the second capsule element is a membrane, especially where the membrane is comparably thin, as the case may be for capsules adapted for insertion into and/or use with a beverage production device. The present inventors have found that upon increased internal capsule pressure, the membrane deforms outwardly to form, ultimately followed by bursting and/or delamination of the membrane from the first capsule element. However, if a capsule element having a rim as described above is used as the first capsule element, the membrane periphery aligns in the direction of the inclined rim when forming a dome. The orthogonal force component is so lower making the strength against delamination of the membrane on the rim much higher.

The rim of the capsule element may be a flange-like rim.

The sidewall of the capsule element can have an upper and a lower end, the upper end defining a circle having a first diameter, the lower end defining a circle having a second diameter, wherein the opening is located at the upper end. The second diameter can be smaller than the first diameter. The bottom wall can be located at the lower end. The bottom wall can be located opposite the opening.

The capsule element can be a capsule body. In the alternative or in addition, the capsule element can be rotationally symmetric or a combination thereof. In certain non-limiting embodiments, the capsule element is of essentially frusto-conical shape or of frusto-conical shape.

The capsule element is formed of a substantially gas-tight, gas tight material. The capsule element can comprise or can be made of any suitable material such as, but not limited to, aluminium or a polymer composition. The polymer composition can be polypropylene or polyethylene but in certain non-limiting embodiments, comprises a gas barrier layer such as EVOH. Aluminium is an exemplary (but non-limiting) material. A laminate of polymer and aluminium is possible such as aluminium-PP.

The capsule element can further comprise a sealing means. The sealing means can be applied to or connected with the rim of the capsule element, so as to allow sealing engagement with a further capsule element, which may be different from the first capsule element. The sealing means can be a sealing lacquer and the like.

It is desired in certain particular non-limiting embodiments that the capsule element according to the presently disclosed and/or claimed inventive concept(s) is a capsule element for preparing a beverage, such as coffee. In particular non-limiting embodiments, the capsule element is adapted for insertion into and/or use with a beverage production device.

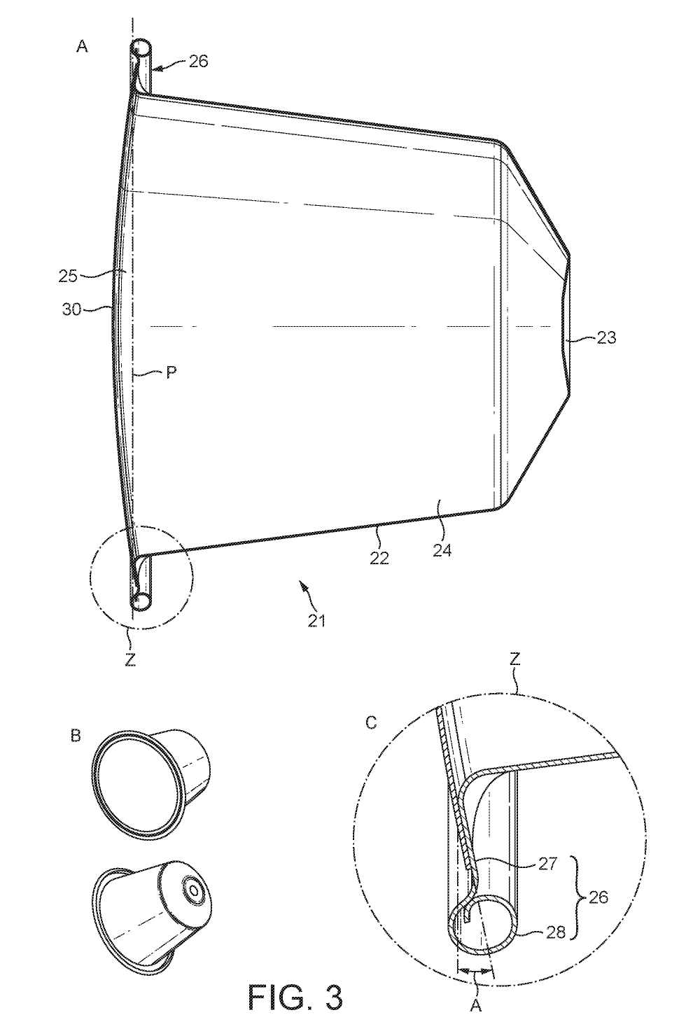

A schematic drawing of one embodiment of an exemplary capsule according to the presently disclosed and/or claimed inventive concept(s) is shown in FIG. 3. The capsule shown in FIG. 3 is one non-limiting embodiment thereof; however, the skilled person understands that the presently disclosed and/or claimed inventive concept(s) is not limited thereto.

The presently disclosed and/or claimed inventive concept(s) further provides for a capsule comprising as a first capsule element a capsule element according to the presently disclosed and/or claimed inventive concept(s), the capsule further comprising a second capsule element for sealing connection with the rim of the first capsule element. The sealing means can be a sealing lacquer and the like.

The second capsule element may be in a sealing connection or a hermetically sealing connection with the rim of the first capsule element. Optionally, the sealing or hermetically sealing connection may be mediated by a sealing means located between the rim of the first capsule element and the adjacent part of the second capsule element. The hermetically sealing connection is substantially gas-tight, or is gas tight.

According to a particular (but non-limiting) embodiment, the second capsule element is a membrane. The membrane may have a thickness of 30 μm to 40 μm, such as 33 μm to 37 μm, or 35 μm. The membrane may be embossed in which case the thickness is regarded as the thickness of the membrane as it was non-embossed and free of lacquer. In the alternative or in addition, the membrane may be impermeable, or substantially impermeable for CO₂. In certain non-limiting embodiments, the membrane is substantially gas-tight, or is gas tight. The membrane can comprise or consist of any suitable material, such as aluminium.

The capsule may comprises a coffee ingredient such as (but not limited to) roast and ground coffee.

The pressure within the capsule may be 300 mbar to 500 mbar, 325 mbar to 475 mbar, 350 mbar to 450 mbar, 375 mbar to 425 mbar or 400 mbar.

The pressure within the capsule can be determined manually by putting the capsule into a pressure controlled box. The pressure is varied until the absolute internal pressure of the capsule (mbar) is equivalent to the absolute pressure in the box (mbar); when the membrane of the capsule becomes floppy at this point. The internal pressure is considered as equal to the absolute pressure in the box and the relative pressure of the capsule is given by the absolute pressure according to the atmospheric pressure. The pressure within the capsule can be a pressure determined after 7 days of storage under ambient (20° C.) conditions.

It is desired in certain non-limiting embodiments that the capsule according to the presently disclosed and/or claimed inventive concept(s) is a capsule for preparing a beverage, such as coffee. In certain particular, non-limiting embodiments, the capsule is adapted for insertion into and/or use with a beverage production device. Accordingly, the capsule may be adapted to allow for the opening of the capsule upon injection of a pressurized liquid, e.g. by tearing or disruption of a capsule element, such as a membrane.

In a particular, non-limiting embodiment, the capsule is a capsule comprising a single serving of ground coffee (e.g., from 5 g-12 g of ground coffee). In certain particular, non-limiting embodiments, this capsule is an hermetically or gas-tightly sealed capsule.

The capsule can be stored at a wide range of temperatures, such as from −30° C. to 50° C., such as from −20° C. to 40° C., or from −10° C. to 30° C., or 0° C. to 20° C.

A schematic drawing of one embodiment of an exemplary capsule according to the presently disclosed and/or claimed inventive concept(s) is shown in FIG. 3. The capsule shown in FIG. 3 is an exemplary (but non-limiting) embodiment); however, the skilled person understands that the presently disclosed and/or claimed inventive concept(s) is not limited thereto.

FIG. 3A shows a schematic side-view of the capsule. The capsule comprises a first capsule element 21 that is of essentially frusto-conical shape and has a side-wall 22 and a bottom wall 23, the side wall and the bottom wall defining an interior chamber 24 having an opening 25. Element 21 comprises a flange-like rim 26 comprising a flat part 27 and a flange 28 that may be curled in certain non-limiting embodiments. The capsule further comprises a second capsule element 30 that is a membrane. The flat part of the rim 26 and a plane spanned by the opening form an angle A of about 12°, as can be seen in more detail in FIG. 3C.

FIG. 3B shows additional views of capsule element 21.

### EXAMPLES

The following examples are not to be construed as limiting.

### Example 1

A capsule comprising ground coffee was prepared, as schematically depicted in FIG. 1.

Initially, coffee beans were roasted, followed by storing in the existing tempering silo or storage at −20° C. Then, beans were fed into the cryogenic equipment. Liquid nitrogen was injected inside the cryogenic equipment, where the beans are in direct contact with the liquid nitrogen. In direct contact with the beans, the liquid nitrogen cools down the beans to the setup temperature value. The beans temperature at the exit of the cryogenic equipment can be adjusted by the ratio between the amount of beans and of liquid nitrogen inside the cryogenic equipment and by the residence time of the beans inside the cryogenic equipment.

A fan can optionally be used to exhaust to the outside the N₂-gas expanded from the liquid nitrogen evaporation (or to recirculate gas to the grinder for example). The cold beans were fed into the grinder. The grinder rolls were cooled by circulation of a cooling fluid (additionally or alternatively, liquid nitrogen could be injected inside the grinder to contact the coffee ingredient). Then, the roasted and ground coffee was compacted by adjustment of the normalizer head opening. The normalizer double jacket was cooled by circulation of a cooling fluid. The coffee is degassed in the degasing unit. This can be done by adjusting the coffee load. The degasing unit double jacket was likewise cooled by circulation of a cooling fluid. Finally, the roasted and ground coffee was dosed in capsules in the filling line. In a possible alternative, the coffee ingredient could be cooled inside the filling line and dosing unit with indirect cooling such as by using a double-jacket circuit, or with direct injection of liquid nitrogen. Also due to operational constraints and to avoid coffee aroma loss during the temporary line stoppage, additional equipment may be required to maintain the coffee cold during such interruptions.

### Example 2

The aroma of capsules comprising ground coffee prepared according to a process of the presently disclosed and/or claimed inventive concept(s) was evaluated. The process is the one described in Example 1.

To that end, the in-cup aroma and the in-room aroma of the capsules was analyzed as outlined below.

Experimental setup
a) In-Cup Coffee Odorant Analysis:

Absolute contents (ppm/g roasted and ground coffee) of key coffee odorants (thiols, sulfides, Strecker aldehydes, diketones, pyrazines and phenols) were determined in-cup using the corresponding isotopic labelled standards in conjunction with SPME/GC/MS (Solid Phase Micro Extraction fiber with Gas Chromatography combined with Mass Spectrometer detector). The coffee odorants were extracted from the roast and ground by weighing 4 g roast and ground (taken from different freshly opened capsules) in 100 mL boiling water and leaving the suspension to extract for 15 min under continuous stirring using a magnetic stirring bar. Every sample was extracted and measured in triplicate. The analysis was split into two groups of analytes.

Group 1 (Analysis of Thiols, Sulfides and Pyrazines)

After extraction, the coffee samples were quickly cooled on ice and 100 mg of cysteine was added to the coffee samples to avoid thiol binding to the coffee matrix during sample work up. Definite amounts of isotope labeled standards were added and the solutions were stirred for 10 min. Subsequently, portions of 7 mL were transferred to headspace vials.

After an equilibration (40° C., 1 min), the aroma compounds were extracted from the headspace during 10 min at 40° C. under agitation (350 rpm) using a divinylbenzene-carboxen-polydimethylsiloxane SPME fiber (StableFlex DVB/CAR/PDMS; 2 cm; film thickness 50/30 μm; Supelco, Buchs, Switzerland). The extracted compounds were thermally desorbed for 3 min into a split/splitless injector maintained at 240° C. and operated in splitless mode. For separation of compounds, an Agilent 7890A gas chromatograph (Agilent Technologies, Morges, Switzerland) with a 60 m×0.25 mm×0.25 μm DB-Wax column was used (Agilent Technologies, Morges, Switzerland). Helium was used as a carrier gas with a constant flow of 1.3 mL/min, and the following temperature program was applied: 40° C. (6 min), 4° C./min, 140° C. (0 min), 20° C./min, 240° C. (10 min). The gas chromatograph was coupled to a 5975C mass spectrometer (Agilent Technologies, Morges, Switzerland) operating in single ion monitoring (SIM) mode using electron ionization and an ionization potential of 70 eV. All GC-MS measurements were run in triplicate. Data were analysed using the MassHunter Quant software (Version B.05.02, Agilent Technologies).

Group 2 (Strecker Aldehydes, Diketones and Phenols)

After cooling the coffee samples on ice and diluting until a final volume of 100 mL, a 4:1 additional dilution was performed. Definite amounts of isotope labeled standards were added and the solutions were stirred for 10 min. Portions of 7 mL were transferred to headspace vials.

The coffee volatiles were extracted and injected into a Thermo Trace Ultra gas chromatograph (Brechbühler, Schlieren, Switzerland) as described above for Group 1. In contrast to Group 1, volatiles were separated on a 60 m×0.25 mm×1.4 μm DB-624 column (Agilent Technologies, Morges, Switzerland). Helium was used as a carrier gas with a constant flow of 1.3 mL/min, and the following temperature program was applied: 40° C. (6 min), 6° C./min, 140° C. (0 min), 20° C./min, 240° C. (10 min). The gas chromatograph was coupled to a Thermo Scientific ISQ mass spectrometer (Brechbühler, Schlieren, Switzerland) operating in single ion monitoring (SIM) mode using electron ionization and an ionization potential of 70 eV. All GC-MS measurements were run in triplicate. Data were analysed using the Xcalibur 2.1 software (Thermo Scientific).

Samples which were produced according to a process of the presently disclosed and/or claimed inventive concept(s) were compared to the corresponding reference sample.

b) Around Machine Coffee Odorant Analysis (Method Using Tenax-GC-MS):

The amount of aroma released around a coffee machine (in microgram) was measured in a hermetically closed glovebox, having electricity supply and containing the coffee machine. Coffees were prepared inside the glovebox using the capsule/machine configuration, using a Nespresso “U” (trademark) machine. A similar preparation was done for reference and samples treated with cryogenic equipment. A representative air sample (225 ml) was sampled from this glovebox directly after beverage preparation. The coffee aroma was trapped onto a Tenax trap (Markes International, Llantrisant, UK), involving a tube packed with Tenax TA adsorbent resin to trap the volatiles passing through the tube. The Tenax trap was subsequently desorbed to the GC-MS in splitless mode by a TD-100 autosampler (Markes International, Llantrisant, UK). The compounds were separated on a DB-FFAP GC column (60 m×0.250 mm×25 um) using following temperature gradient: 30° C. for 10 min; increase at 4° C./min until 50° C.; increase at 10° C./min until 245° C. and hold until 35 min. The components were detected by a 5975C single quad mass spectrometer (Agilent Technologies, Morges, Switzerland) operating in SIM mode. Data were analysed using the MassHunter Quant software (Version B.05.02, Agilent Technologies). Again, a representative group of key coffee odorants (thiols, sulfides, Strecker aldehydes, diketones, pyrazines and phenols) was measured. Samples which were produced according to a process of the presently disclosed and/or claimed inventive concept(s) were compared to the corresponding reference sample. Every sample was extracted and measured at least four times.

Results

The table below gives an overview of the differences measured in-cup and around the machine in terms of the key coffee odorants. For every blend, a comparison was made with the corresponding reference product, which was considered as 100%.

comparison (%) relatively to untreated
product (considered as 100%)

| | in-cup | error (%) | around machine | error (%) |
|---|---|---|---|---|
| Arpeggio | 130 | 2 | 169 | 11 |
| Ristretto | 134 | 5 | 135 | 16 |

| | | | |
|---|---|---|---|
| Indryia | 121 | 6 | n/a |
| Roma | 124 | 5 | n/a |
| Fortissio | 123 | 9 | n/a |
| Other blend | 130 | 2 | n/a |

### Example 3

In a further experiment, the capsules were evaluated by determining sensory profiles.

Experimental Setup

Comparative profiles were obtained from 12 assessors using a simplified cupping procedure determining crema, aroma, flavour, and texture. The procedure was repeated once. Nespresso Concept (trademark) machines filled with Nestlé Aqua Panna water were used to test the capsules according to the presently disclosed and/or claimed inventive concept(s) as well as reference capsules at 40 ml of dosage.

Sensory Profiles

The objective was to evaluate the sensory impact of the coffee prepared from capsules obtained according to a process of the presently disclosed and/or claimed inventive concept(s). The coffee beans were roasted coffee, tempered and pre-cooled at −20° C. and then ground, normalized and degased during 5 min at 5° C. The roast and ground coffee was then directly filled into the capsule at the corresponding weight depending of the blend. The capsules were evaluated against capsules containing coffee processed according to a standard process (reference). In the standard process, coffee beans were roasted, tempered, ground, normalized, then degased during 30 min at 30° C. and then directly filled into the capsule at the corresponding weight depending of the blend. A lot of attributes were found to be significantly improved in the intense coffee blends prepared according to the presently disclosed and/or claimed inventive concept(s):

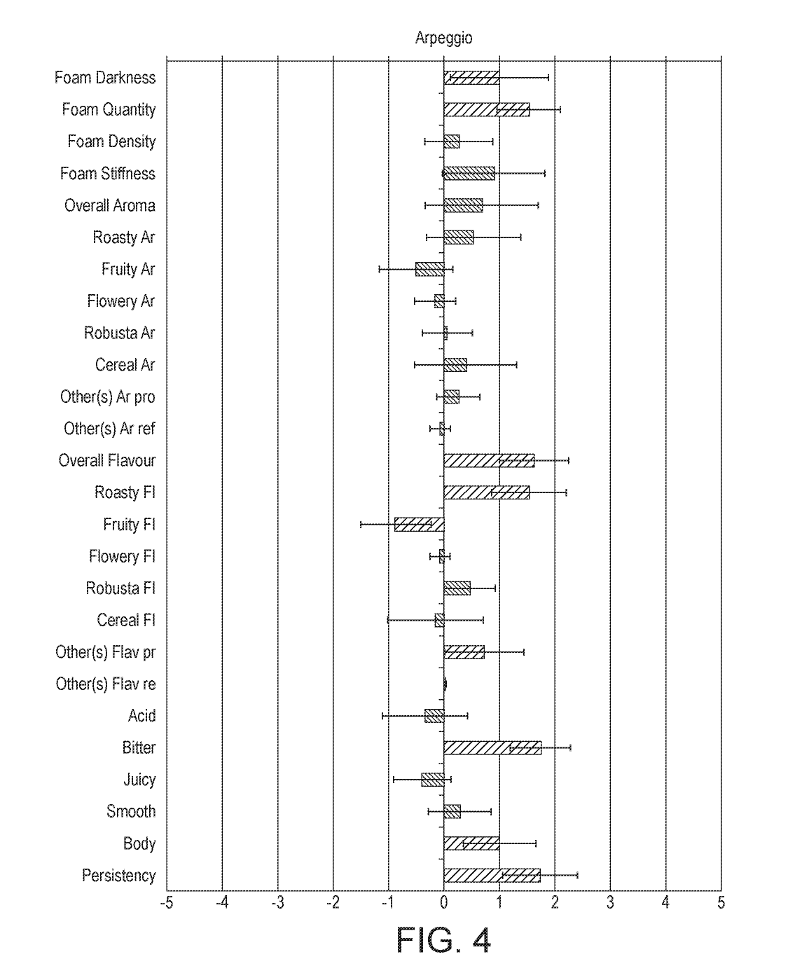

Arpeggio (a coffee blend identical to the one contained in the commercial Arpeggio capsule) from a capsule produced according to the presently disclosed and/or claimed inventive concept(s) (batch 222173) was perceived more intense and roasty in flavour, more bitter/persistent than the reference (batch 216205) as well as with more body. The crema was found darker and with more quantity. See also FIG. 4. Bars with spaced hatching signify the presence of a significant difference for a given attribute, confidence interval 95%.

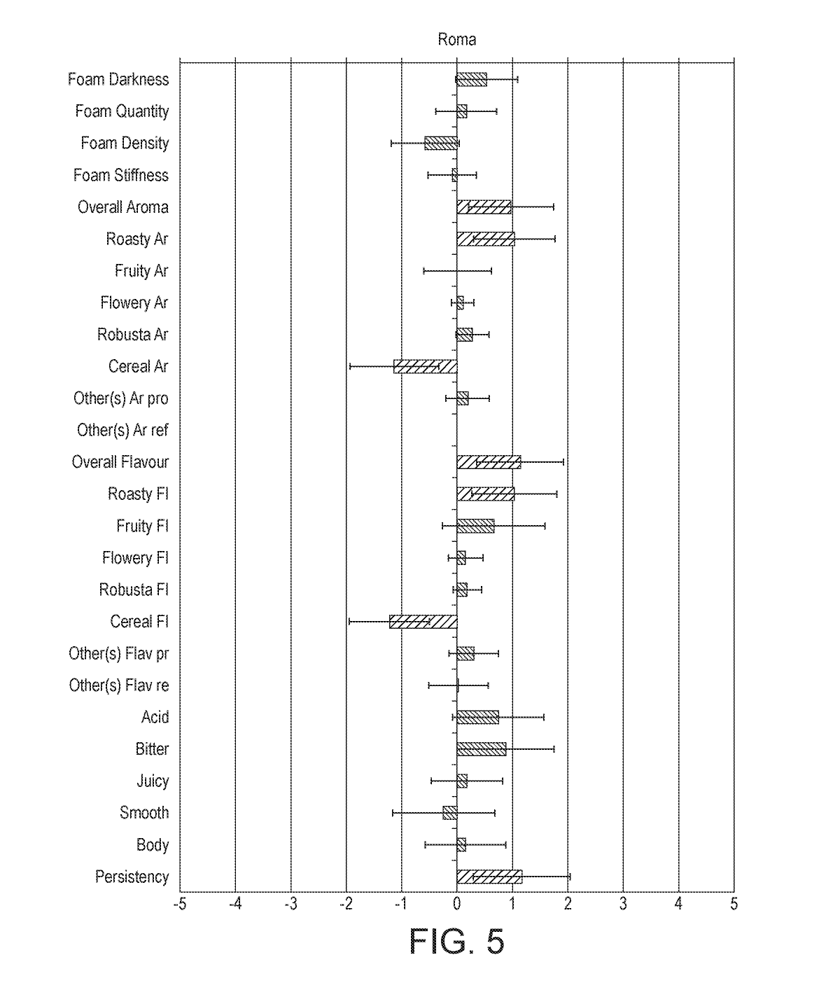

Roma (a coffee blend identical to the one contained in the commercial Roma capsule) from a capsule produced according to the presently disclosed and/or claimed inventive concept(s) (batch 228195) was found more intense/roasty/cereal in overall aroma and flavour as well as more persistent than the reference (batch 228193). See also FIG. 5. Bars with spaced hatching signify the presence of a significant difference for a given attribute, confidence interval 95%.

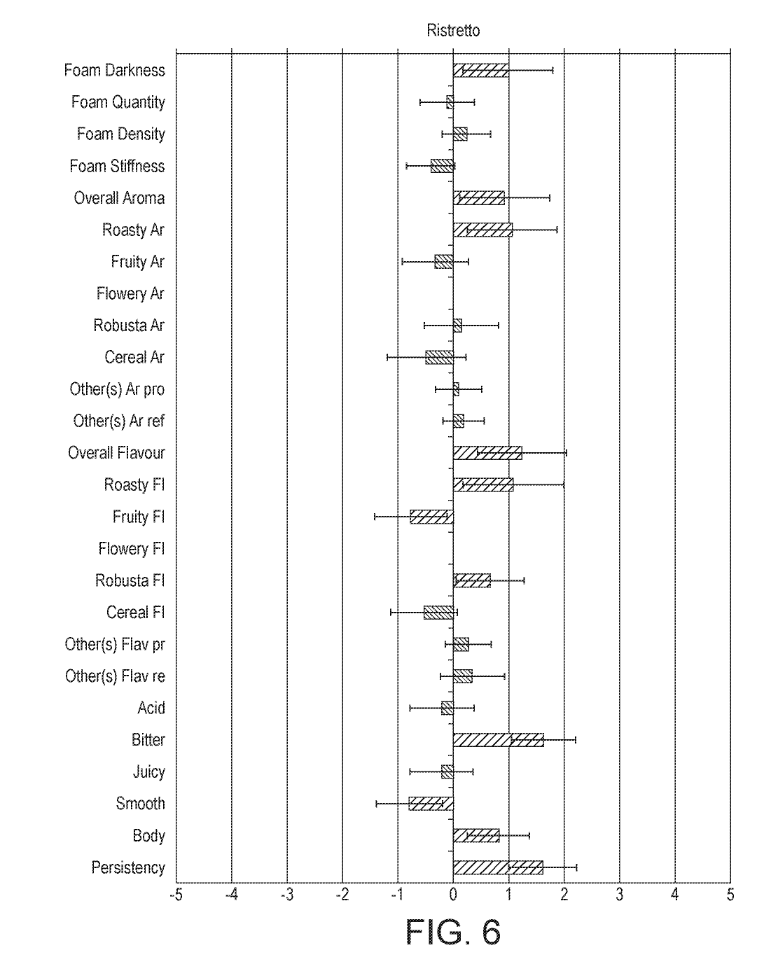

Ristretto (a coffee blend identical to the one contained in the commercial Ristretto capsule) from a capsule produced according to the presently disclosed and/or claimed inventive concept(s) (batch 227025) was darker, more intense in overall aroma/flavour, more roasty (aroma/flavour), less fruity (flavour), more robusta, more bitter, less smooth with more body and more persistent that the reference (batch 222569). See also FIG. 6. Bars with spaced hatching signify the presence of a significant difference for a given attribute, confidence interval 95%.

### Example 4

It was demonstrated that the aroma retention increases with a decrease of the processing temperature. Cold processing with pre-cooled roasted coffee enhances aroma recovery. Consumer preference was also demonstrated by a preference test: win on Arpeggio with similar net weight and parity on Fortissio with reduced net weight.

However, due to the reduced degassing time and temperature during cold processing, higher retention of CO₂ results in a higher internal pressure in the filled and sealed capsule. Together with the aroma retention, the carbon dioxide release from the coffee is reduced, which leads to higher capsule internal pressure. Consequently, this higher internal capsule pressure was raised as a major technical constraint when using cold processing with pre-cooled roasted coffee.

Preliminary results from mechanistic model have demonstrated that increased initial rim angle should help the membrane to resist to higher pressures. Consequently, the objective was to demonstrate the impact of higher rim angle at laboratory scale on capsule resistance in order to see potential benefit for capsules with over-pressure as well as the impact of thicker membrane.

The objective was to modulate the capsule internal pressure from 300 mbar to 500 mbar with higher rim angle (12 to 28 degrees). Trials with the standard membrane (30 μm) were performed on Arpeggio blend under different degassing and temperature conditions with cold processing, as shown in FIG. 2.

From 12° to 16° rim angles, capsules were bent directly on the pilot plant. Other capsules with rim angles superior to 16° at time zero were bent manually.

Process parameters are summarized in the table below.

| | | | | | | |
|---|---|---|---|---|---|---|
| | | Cooling | | | | |
| | | water T° C. | | Mem- | | Internal |
| | Roasted | Grinder/ | De- | brane | | Pressure |
| | Beans | Normalizer/ | gassing | Thick- | Rim | (mbar |
| | temp. | Degassing | time | ness | Angle | after |
| Trials | (° C.) | unit | (min) | (μm) | (degree) | 7 days) |

Arpeggio

| | | | | | | |
|---|---|---|---|---|---|---|
| Ref. 1 | −20 | 5°/5°/30° C. | 5/20/35 | 30 | 12°/16°/19° | 300/400/ |
| | | | | | 21°/28° | 500 |
| Ref. 2 | −20 | 5°/5°/5° C. | 5/20/35 | | 12°/16°/19° | 300/400/ |
| | | | | | 21°/28° | 500 |

Ristretto

| | | | | |
|---|---|---|---|---|
| Ref. 3 | Industrial trial conditions | 40 | 12° | 400/500 |

Capsules were analyzed for internal pressure. Capsule internal pressure was measured by placing the capsule in a pressurized chamber (as described earlier) 7 days after filling.

Rim angles were measured at time zero and 3 times over 8 weeks with a laser instrument. The instrument is a laser which can measure the angle between the two points as described in the present patent application.

The rim angle was defined by the level between two points placed on the flat part of the rim. These two points have to be on the capsule diameter. Membrane protection just after the sealing process and delamination are the two arguments which play a role for the rim angle determination. Based on these two arguments, it was demonstrated that the recommended folding angle was around 12±2° in order to avoid the membrane damage and limit delamination (for capsules showing high internal pressure).

Capsule resistance was tested visually on the membrane.

Delamination Test: Storage test consists of the delamination evaluation (visual capsule resistance) of the Arpeggio or Ristretto capsules produced under different conditions of cold processing (rim angles & capsule internal pressure; see trials description above). All capsules are kept in temperature and humidity controlled chambers at 30° C. and 70% Rh (relative humidity). The capsules resistance was evaluated every week over 3 months which mimic one year shelf life at room temperatures.

Capsule resistance was found to increase with higher rim angle. At 500 mbars of capsule internal pressure, no delamination was observed over the 3 months at 30° C. with rim angle >20°. Capsule resistance at intermediate internal pressure (400 mbar) was visually ok from rim angles >16°. Delamination of the membrane was only observed from 12° to 16° on one capsule after 6 weeks at 30° C. with standard membrane (30 μm) and no delamination noted with the thicker membrane (40 μm). Rim angles noted correspond to measurements performed at time zero.

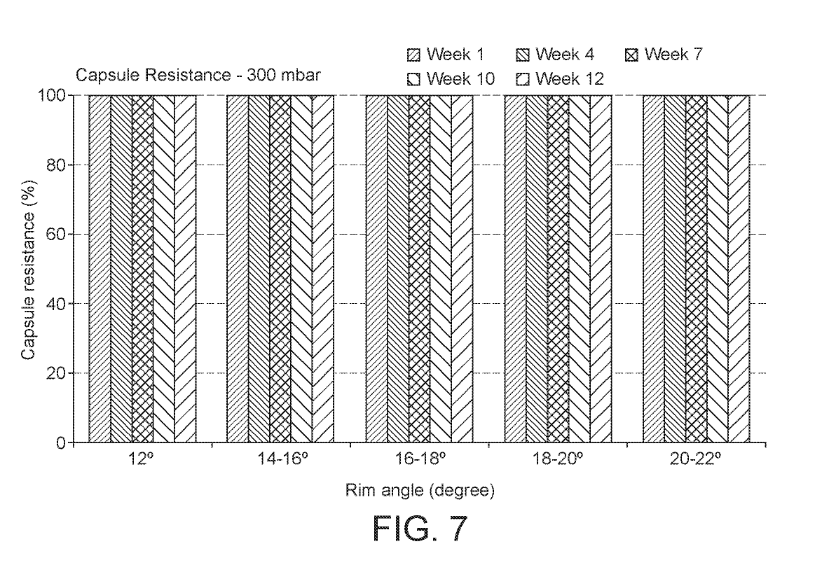

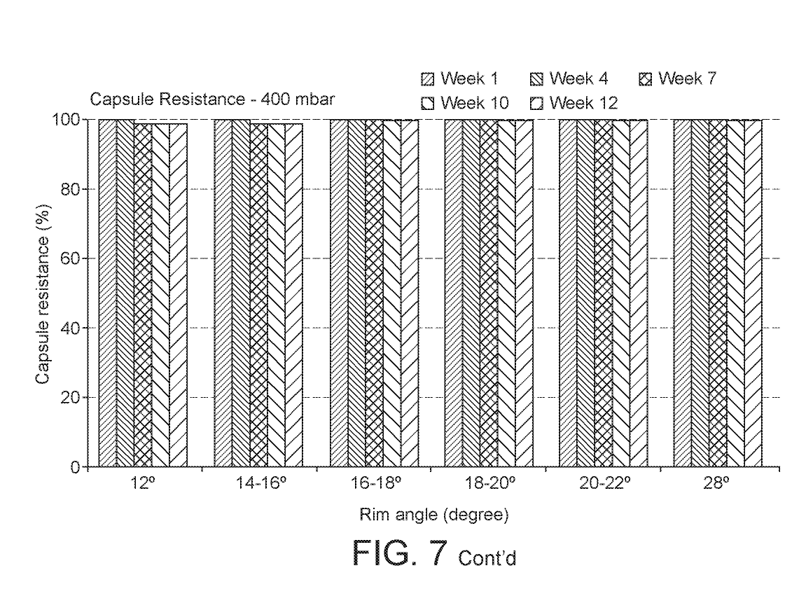

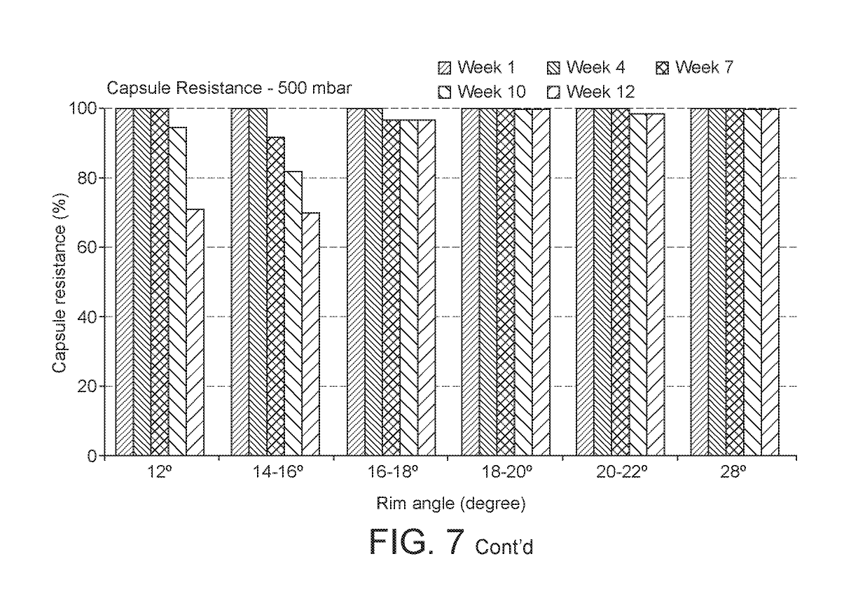

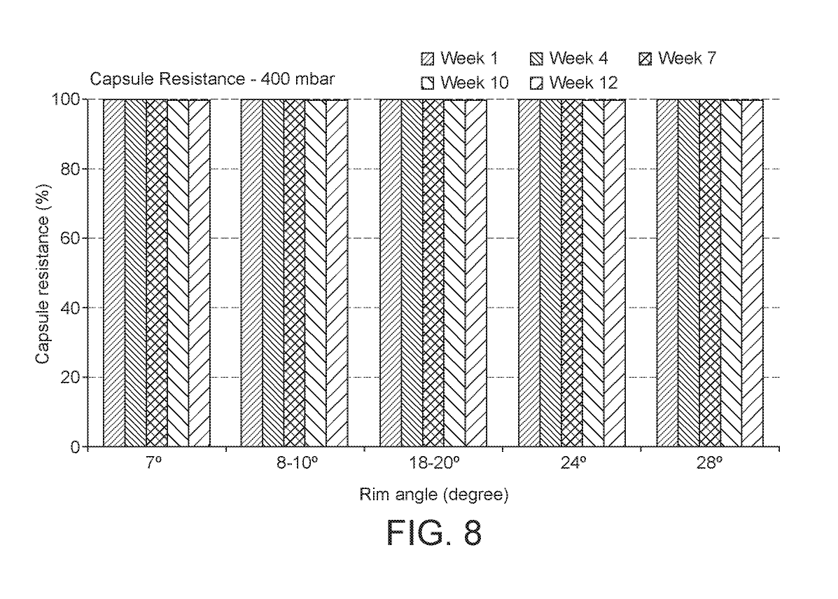

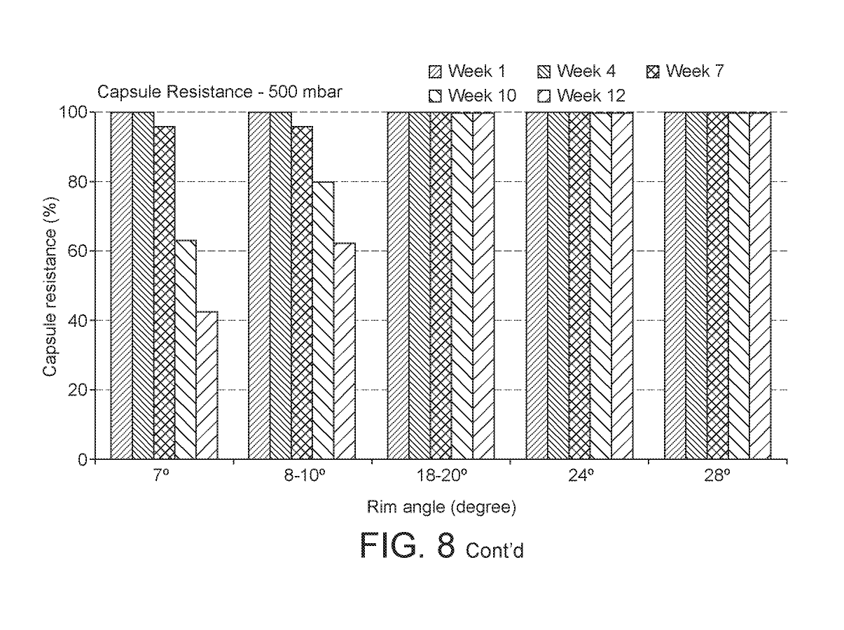

Exemplary results for 30 μm and 40 μm membranes are shown in FIGS. 7 and 8, respectively. FIG. 7 shows capsule resistance over 3 months at 30° C./70% Rh (internal pressure from 300 to 500 mbars and rim angles from 12° to 28° with a standard membrane 30 μm). FIG. 8 shows capsule resistance over 3 months at 30° C./70% Rh (internal pressure from 400 to 500 mbars and rim angles from 7° to 28° with a thicker membrane 40 μm)

To summarize, capsule over-pressure (up to 500 mbar) can be managed with higher rim angle.

1. A process of preparing a capsule comprising a ground coffee ingredient, the process comprising the steps of:
(a) cooling a coffee ingredient to a temperature in a range of from about −50° C. to about 10° C.;
(b) grinding the coffee ingredient;
(c) filling the coffee ingredient into a first capsule element; and
(d) hermetically sealing the first capsule element with a second capsule element.

2. The process according to claim 1, wherein the coffee ingredient is maintained at a temperature in a range of from about −50° C. to about 10° C. in step (b) and/or in step (c).

3. The process according to claim 1, further comprising the step of:
(a)′ roasting the coffee ingredient; and
wherein step (a)′ is performed prior to step (a).

4. The process according to claim 1, further comprising the step of:
(a)″ tempering the coffee ingredient; and
wherein step (a)″ is performed prior to step (a).

5. The process according to claim 1, further comprising the step of:
(c)′ compressing the coffee ingredient, optionally wherein the coffee ingredient is cooled during compressing; and
wherein step (c)′ is performed after step (b) and prior to step (c).

6. The process according to claim 1, further comprising the step of:
(c)″ degasification of the coffee ingredient, optionally wherein the coffee ingredient is cooled during degasification; and
wherein step (c)″ is performed after step (b) and prior to step (c).

7. The process according to claim 6, wherein the degasification in step (c)″ is performed for about 120 minutes or less.

8. The process according to claim 1, wherein the process does not comprise any degasification step.

9. The process according to claim 1, wherein in step (a), the coffee ingredient is cooled to a temperature in a range of from about −45° C. to about 5° C.

10. The process according to claim 1, wherein the coffee ingredient is maintained at a temperature in a range of from about −45° C. to about 5° C. in step (b) and/or in step (c).

11. The process according to claim 1, wherein the first capsule element of step (c) comprises a rim, at least one sidewall, and a bottom wall, the rim being for sealing engagement with a second capsule element, wherein the at least one side wall and the bottom wall define an interior chamber having an opening, the opening spanning a plane, wherein further the rim extends outwards from the sidewall and surrounds the opening, the rim being bent into the direction of the bottom wall, the rim and the plane of the opening forming an angle of at least about 10°, optionally wherein the angle (A) is in a range of from about 10° to about 28°.

12. The process according to claim 1, wherein a vacuum or a reduced pressure is applied to the first capsule element after filling the ground coffee ingredient into the first capsule element and before the first capsule element is hermetically sealed with the second capsule element, optionally wherein the reduced pressure applied to the first capsule element is about 100 mbar to about 800 mbar under atmospheric pressure.

13. The process according to claim 1, wherein the first capsule element forms a capsule body, wherein the first capsule element is rotationally symmetric and optionally wherein the first capsule element is also of essentially frusto-conical shape.

14. The process according to claim 1, wherein the second capsule element of step (d) is a membrane, optionally wherein the membrane has a thickness about 30 μm to about 40 μm and/or wherein the membrane is impermeable for CO₂.

15. The process according to claim 1, wherein no gas scavenger is filled or inserted into the first capsule element before sealing by the second element.

16. The process according to claim 1, wherein the coffee ingredient is roasted coffee.

17. A capsule obtainable by the process according to claim 1.
